(19) United States
(12) Patent Application Publication
(10) Pub. No.: US 2024/0185413 A1
(43) Pub. Date: Jun. 6, 2024

(54) Fastener Bulb Inspection Device

(71) Applicant: The Boeing Company, Arlington, VA (US)

(72) Inventor: Farahnaz Sisco, Mukilteo, WA (US)

(21) Appl. No.: 18/504,799

(22) Filed: Nov. 8, 2023

Related U.S. Application Data
(60) Provisional application No. 63/386,272, filed on Dec. 6, 2022.

(51) Int. Cl. G06T 7/00; G06T 7/13

(52) U.S. Cl. CPC G06T 7/001; G06T 7/13; G06T 2207/30108

(57) ABSTRACT

Fastener bulb inspection devices and methods of use. A fastener bulb inspection device comprises a support providing a desired vertical position relative to an access hole of a structure with a fastener to be inspected; a gimbal connected to the support; and an inspection sensor connected to the gimbal by a telescopic arm.

### CROSS-REFERENCE TO RELATED APPLICATION

This application claims the benefit of U.S. Provisional Patent Application Ser. No. 63/386,272, filed Dec. 6, 2022, and entitled “Fastener Bulb Inspection Device,” which is incorporated herein by reference in its entirety.

### BACKGROUND INFORMATION

### 1. Field

The present disclosure relates generally to fastening, and more specifically to a fastener bulb inspection device and methods of measuring a fastener bulb.

### 2. Background

In a manufacturing environment, such as, for example, the manufacture of aircraft, various parts or components are connected to each other to form structures or substructures. Installation of mechanical fasteners such as, for example, blind fasteners or one-side fasteners, is generally conducted in order that the fastener is in flush alignment (i.e., no gaps) to the surface of the part.

A blind fastener includes an internally threaded body and an externally threaded core bolt that passes through the internally threaded body. One end of the core bolt has an enlarged head, while the other end has an engaging portion. Rotation of the core bolt relative to the body causes axial movement of the core bolt in an outwardly direction from the body. Such axial movement thereby causes deformation of the body outwardly in a manner that forms a bulb that engages an inner surface of the part, thereby securing the blind fastener in place and attaching the parts to each other. When installing a blind fastener, a portion of the head of the core bolt typically fractures leaving a flush surface on the installed fastener head.

The structural integrity of the connection between parts that is facilitated by the fastener may be compromised in the event the fastener has variability in its shape or size and/or the fastening hole of the part(s) to be fastened are offset due to machining tolerances. Inspection of installed fasteners such as, for example blind fasteners or one-side fasteners is often difficult, if not impossible due to the fact that the relatively tight access spaces and/or enclosed location of the fasteners make access to the “blind” side of the part(s) difficult and/or unavailable.

Therefore, it would be desirable to have a method and apparatus that takes into account at least some of the issues discussed above, as well as other possible issues.

### SUMMARY

An embodiment of the present disclosure provides a fastener bulb inspection device. The fastener bulb inspection device comprises a support providing a desired vertical position relative to an access hole of a structure with a fastener to be inspected; a gimbal connected to the support; and an inspection sensor connected to the gimbal by a telescopic arm.

Another embodiment of the present disclosure provides a fastener bulb inspection device. The fastener bulb inspection device comprises a telescopic arm; a gimbal connected to a first side of the telescopic arm; and an inspection sensor connected to a second side of the telescopic arm, the inspection sensor configured to inspect a bulb of a fastener.

Yet another embodiment of the present disclosure provides a method of inspecting a bulb of a fastener. An inspection sensor is placed into a confined space containing the bulb of the fastener. The inspection sensor is aligned relative to the bulb of the fastener. The bulb of the fastener is inspected. It is determined if the bulb of the fastener is within tolerance.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a fastener system after in accordance with an illustrative embodiment;

FIG. 4 is an illustration of a top view of a fastener system after installation in accordance with an illustrative embodiment;

FIG. 5 is an illustration of a fastener bulb inspection device and a structure with a fastener to be inspected in accordance with an illustrative embodiment;

FIG. 6 is an illustration of a fastener bulb inspection device and a structure with a fastener to be inspected in accordance with an illustrative embodiment;

FIG. 7 is an illustration of a fastener bulb inspection device and a number of fasteners to be inspected in accordance with an illustrative embodiment;

FIG. 8 is an illustration of a fastener bulb inspection device in accordance with an illustrative embodiment;

FIG. 9 is an illustration of an overlay of an image with a bulb and a reference image in accordance with an illustrative embodiment;

FIG. 10 is an illustration of an overlay of an image with a bulb and a reference image in accordance with an illustrative embodiment;

FIG. 11 is a flowchart of a method of inspecting a bulb of a fastener in accordance with an illustrative embodiment;

FIG. 12 is a flowchart of a method of inspecting a bulb of a fastener in accordance with an illustrative embodiment;

FIG. 13 is an illustration of an aircraft manufacturing and service method in a form of a block diagram in accordance with an illustrative embodiment; and

FIG. 14 is an illustration of an aircraft in a form of a block diagram in which an illustrative embodiment may be implemented.

### DETAILED DESCRIPTION

The illustrative examples recognize and take into account one or more different considerations. For example, the illustrative examples recognize and take into account that operating robots, such as end effectors on robotic arms, within a manufacturing environment involves additional safety considerations. The illustrative examples recognize and take into account that human operators are prohibited from entering within a set distance of an area while a robot is active in the area. The illustrative examples recognize and take into account that to provide a safe operating condition for human operators, the operating area is typically a large footprint surrounding the robot. The illustrative examples recognize and take into account that it can be desirable to perform operations without the use of robotics to due to the safety requirements for robots within a manufacturing environment.

The illustrative examples provide a fastener bulb inspection device. The fastener bulb inspection device of the illustrative examples is a mechanical system utilizing hard tooling instead of a robot. By utilizing hard tooling fixturing, a smaller platform and a smaller operating space can be provided. By utilizing hard tooling fixturing, additional operations can be performed within the manufacturing area.

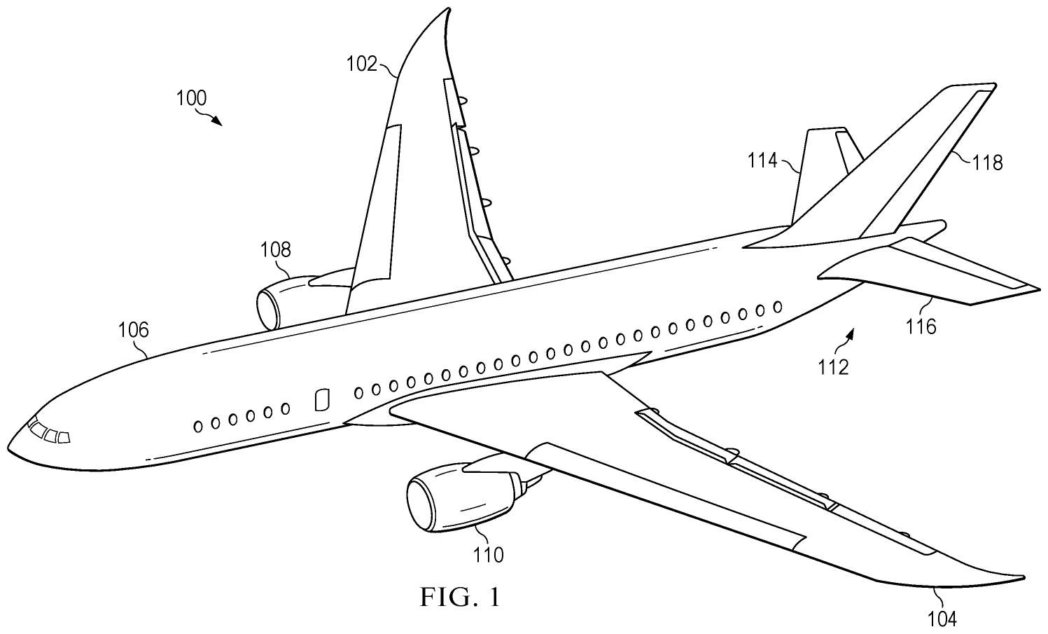

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft having fasteners to be inspected. For example, at least one of body 106, wing 102, or wing 104 can have fasteners to be inspected within a confined space.

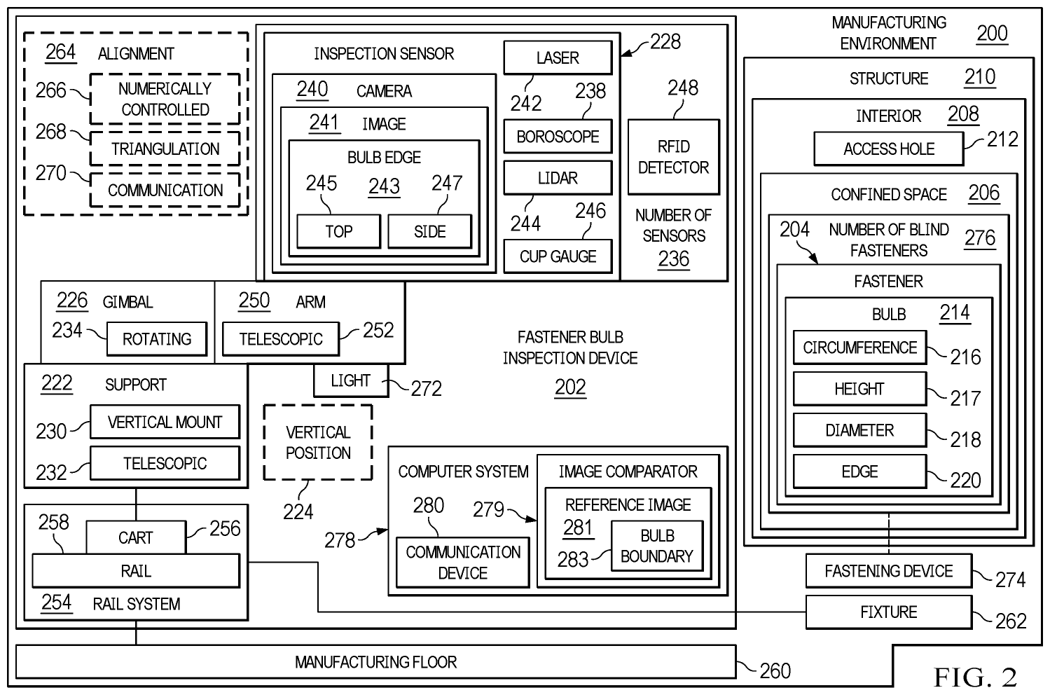

Turning now to FIG. 2, an illustration of a block diagram of a manufacturing environment is depicted in accordance with an illustrative embodiment. Portions of aircraft 100 can be manufactured in manufacturing environment 200. In some illustrative examples, structure 210 is a component of aircraft 100 of FIG. 1, such as portion of wing 102 or wing 104.

Fastener bulb inspection device 202 is configured to inspect fastener 204 within confined space 206 of interior 208 of structure 210. Fastener bulb inspection device 202 comprises support 222, gimbal 226 connected to support 222, and inspection sensor 228 connected to gimbal 226 by telescopic 252 arm 250. Although gimbal 226 is depicted, any desirable universal joint can be provided. Gimbal 226 is configured to provide for movement about three axes. In some illustrative examples, an alternative joint other than gimbal 226 is provided to allow for movement of telescopic 252 arm 250 about three axes.

Although not depicted here, in some other illustrative examples, a rotational joint can connect inspection sensor 228 and telescopic 252 arm 250. In some illustrative examples, a moveable joint connects inspection sensor 228 to telescopic 252 arm 250 so that inspection sensor 228 can move independently of telescopic 252 arm 250 and gimbal 226.

Support 222 provides desired vertical position 224 relative to access hole 212 of structure 210 with fastener 204. In some illustrative examples, support 222 can be referred to as vertical mount 232. In some illustrative examples, support 222 is telescopic.

In some illustrative examples, cart 256 is connected to support 222. In some of these illustrative examples, cart 256 is connected to rail 258 of rail system 254. Rail 258 is configured to enable movement of support 222 relative to structure 210.

In some illustrative examples, rail 258 is configured to be connected to fixture 262 supporting structure 210. In other illustrative examples, rail 258 is configured to be connected to manufacturing floor 260.

Fastener bulb inspection device 202 is used to determine if bulb 214 of fastener 204 is out of tolerance. In some illustrative examples, bulb 214 is out of tolerance if the shape of bulb is not round. In some illustrative examples, bulb 214 is out of tolerance if any diameter 218 of bulb 214 is greater than a set value. In some illustrative examples, to determine if bulb 214 of fastener 204 is out of tolerance, diameter 218 is determined.

Inspection sensor 228 can take any desirable form. In some illustrative examples, inspection sensor 228 can be at least one of borescope 238, camera 240, laser 242, lidar 244, or cup gauge 246. In some illustrative examples, inspection sensor 228 comprises cup gauge 246 for mechanical inspection. In some illustrative examples, inspection sensor 228 comprises camera 240. In some illustrative examples, inspection sensor 228 comprises laser 242. Inspection sensor 228 is configured to generate data concerning bulb 214. In some illustrative examples, the inspection data can comprise one or more of image data, measurement data, and spatial proximity/position data of fastener 204. The inspection data can be used to determine at least one of circumference 216, diameter 218, or edge 220 of bulb 214 of fastener 204.

Camera 240 can generate image 241 of fastener 204 with bulb 214. In some illustrative examples, inspection sensor 228 comprises camera 240, and inspection sensor 228 is positioned adjacent bulb 214 of so that diameter 218 and height 217 of bulb 214 is visible to inspection sensor 228. When camera 240 is adjacent fastener 204, camera 240 generates image 241 of fastener 204.

In some illustrative examples, a comparison of image 241 and reference image 281 is conducted. In some illustrative examples, image 241 is overlaid with reference image 281.

To perform a comparison of image 241 and reference image 281, bulb edge 243 is identified. Bulb edge 243 comprises side 247 and top 245. In some illustrative examples, bulb edge 243 is compared to bulb boundary 283 of reference image 281. In some illustrative examples, side 247 is compared to bulb boundary 283 to determine if diameter 218 is in tolerance. In some illustrative examples, side 247 comprises one point in image 241. In some illustrative examples, side 247 comprises multiple points in image 241. In some illustrative examples, side 247 comprises a line or arc of bulb edge 243.

In some illustrative examples, top 245 is compared to bulb boundary 283 to determine if height 217 is in tolerance. In some illustrative examples, top 245 comprises one point in image 241. In some illustrative examples, top 245 comprises multiple points in image 241. In some illustrative examples, top 245 comprises a line or arc of bulb edge 243.

Image comparator 279 can receive image 241 and analyze image 241 to determine if bulb 214 is in tolerance. In some illustrative examples, image comparator 279 can overlay image 241 over reference image 281. In some illustrative examples, image comparator 279 performs image recognition to identify bulb edge 243. In some illustrative examples, image comparator 279 performs image recognition to identify at least one of top 245 or side 247.

In some illustrative examples, bulb boundary 283 comprises a pictoral representation of acceptable ranges of values for diameter 218 and height 217. In some illustrative examples, if bulb edge 243 is positioned within bulb boundary 283, bulb 214 is in tolerance. In some illustrative examples, if at least a portion of bulb edge 243 extends outside of bulb boundary 283, at least one of diameter 218 or height 217 of fastener 204 is out of tolerance.

In some illustrative examples, utilizing image comparator 279 and image 241 is a go-no-go analysis by image comparison. If image comparator 279 determines that bulb edge 243 extends outside of bulb boundary 283, then bulb 214 can be identified as out of tolerance.

In some illustrative examples, a direct go-no-go measurement is conducted. In some of these illustrative examples, cup gauge 246 can be used. Cup gauge 246 is used for mechanical inspection. In some illustrative examples, image data is generated and then analyzed to determine measurements of bulb 214. In some illustrative examples, camera 240 or borescope 238 generates image data to be analyzed for measurements of bulb 214.

Number of sensors 236 comprises one or more sensors configured to detect, determine, assess, monitor, measure, quantify, and/or sense information about fastener 204. As used herein, “sensor” means any device, component, and/or system that is to perform one or more of detecting, determining, assessing, monitoring, measuring, quantifying, and sensing one or more things in manufacturing environment 200.

In some illustrative examples, inspection sensor 228 can also be used to align inspection sensor 228 relative to fastener 204. For example, image data from camera 240 can be used to align inspection sensor 228 such that inspection sensor 228 is over bulb 214. In some illustrative examples, it is desirable for inspection sensor 228 to provide a “top down” view of bulb 214. In some illustrative examples, it is desirable for inspection sensor 228 to provide data for the entirety of bulb 214. In some illustrative examples, it is desirable for the entirety of bulb 214 to be visible to inspection sensor 228.

In some illustrative examples, inspection sensor 228 is one of number of sensors 236 connected to telescopic 252 arm 250, and wherein number of sensors 236 is further configured to perform alignment of inspection sensor 228 relative to fastener 204. In some illustrative examples, RFID detector 248 can be used for alignment 264 of inspection sensor 228.

Alignment 264 of inspection sensor 228 can be a single step or multi-step. In some illustrative examples, alignment 264 includes a macro alignment followed by a micro alignment. In some illustrative examples, alignment 264 includes an initial movement of fastener bulb inspection device 202 based on design data or communicated data from manufacturing and then adjusted based on data received from number of sensors 236. In some illustrative examples, alignment 264 is performed using data received at communication device 280. In some illustrative examples, alignment 264 is performed using data received from a drill (not depicted). In some illustrative examples, alignment 264 is performed using data received from fastening device 274.

Communication device 280 can be present in any desirable location. In some illustrative examples, communication device 280 is present within computer system 278. In some illustrative examples, computer system 278 can be present on cart 256. Communication device 280 is configured to receive position information from fastening device 274 for alignment of inspection sensor 228 relative to the fastener 204.

In some illustrative examples, alignment 264 of inspection sensor 228 is numerically controlled 266. Alignment 264 of inspection sensor 228 can use numerically controlled 266 movements based a designed location for fastener 204. In some illustrative examples, inspection of fastener 204 can be performed after alignment 264 the inspection sensor based on the designed location. In some other illustrative examples, the designed location provides an initial location for alignment of inspection sensor 228.

In some illustrative examples, after moving to the initial location, triangulation 268 is performed to locate fastener 204. In some illustrative examples, alignment 264 includes communication between fastener bulb inspection device 202 and fastening device 274 regarding an actual position of fastener 204 within manufacturing environment. In some illustrative examples, number of sensors 236 perform further alignment 264 based on a detected location of fastener 204 to position number of sensors 236 relative to fastener 204 prior to inspecting fastener 204.

In some illustrative examples, alignment 264 of inspection sensor 228 relative to bulb 214 of fastener 204 comprises at least one of rotating inspection sensor 228, extending inspection sensor 228, or retracting inspection sensor 228. Fastener bulb inspection device 202 comprises telescopic 252 arm 250, gimbal 226 connected to a first side of telescopic 252 arm 250, and inspection sensor 228 connected to a second side of telescopic 252 arm 250, inspection sensor 228 configured to inspect bulb 214 of fastener 204. Gimbal 226 allows for rotating 234 inspection sensor 228. Telescopic 252 arm 250 allows for extending and retracting inspection sensor 228 in confined space 206 of interior 208 of structure 210.

In some illustrative examples, alignment 264 of inspection sensor 228 comprises positioning inspection sensor 228 above bulb 214. In some illustrative examples, alignment 264 of inspection sensor 228 comprises positioning inspection sensor 228 such that the whole of bulb 214 is visible to inspection sensor 228. Alignment 264 of inspection sensor 228 is performed such that inspection sensor 228 can inspect the whole of bulb 214.

In some illustrative example, fastener bulb inspection device further comprises rail system 254, wherein inspection sensor 228 is connected to rail system 254 to translate relative to structure 210 comprising fastener 204. In some illustrative examples, rail system 254 is connected to manufacturing floor 260. In some illustrative examples, rail system 254 is connected to fixture 262 supporting structure 210 or connected to structure 210. In some illustrative examples, cart 256 could run over a skin or other surface of structure 210 if fastener bulb inspection device 202 is light enough to travel on structure 210 without undesirably affecting structure 210.

In some illustrative examples, inspection sensor 228 is part of number of sensors 236 connected to telescopic 252 arm 250. In some illustrative examples, number of sensors 236 comprise at least one of borescope 238, camera 240, laser 242, LIDAR 244, cup gauge 246, or RFID detector 248.

Number of sensors 236 is configured for at least one of manual control by a user or automatic control by computer system 278 to detect, determine, assess, monitor, measure, quantify, and/or sense information about fastener 204. The inspection data can comprise one or more of image data, measurement data, and spatial proximity/position data of fastener 204. In some illustrative examples, bulb 214 is evaluated by conducting a comparison between the inspection data from inspection sensor 228 and a predetermined threshold measurement.

Fastener 204 is one of number of blind fasteners 276 in confined space 206. Inspection sensor 228 can be moved within confined space to inspect each of number of blind fasteners 276. By moving at least one of gimbal 226, telescopic 252 arm 250, and support 222, inspection sensor 228 is placed within confined space 206 relative to a respective fastener of number of blind fasteners 276.

In some illustrative examples, computer system 278 can be used to store at least one of inspection data from inspection sensor 228 or predetermined tolerance values. In some illustrative examples, computer system 278 can numerically control operation of fastener bulb inspection device 202.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, although fastener bulb inspection device 202 is depicted as connected to rail system 254, in some illustrative examples, rail system 254 is optional. In some illustrative examples, fastener bulb inspection device 202 is connected to cart 256 that is manual. In some illustrative examples, cart 256 can be pulled or pushed by an operator within manufacturing environment 200.

Although different types of sensors are listed in number of sensors 236, any desirable type of sensor can be used. In some illustrative examples, number of sensors 236 comprises one or more sensors including, but not limited to, infrared sensors, proximity/position sensors, laser sensors, ultraviolet sensors, heat sensors, and image sensors (e.g., cameras).

Although the illustrative examples discuss the use of fastener bulb inspection device 202 for the inspection of bulb 214 of fastener 204, inspection data can be collected for other types of fasteners or other types of features. For example, inspection data can comprise any information corresponding to one or more structural features (e.g., blind bulb, nut, collar, pin protrusion, thin sleeve protrusion, a fastener head, a nut-and-pin protrusion, a swaged collar, a bracket, an insert, a clip, a trimmed or machined feature, etc.) and spatial relationship (s) between the fastener F and the inspection environment E that falls within the spirit and scope of the principles of this disclosure set forth herein. In one or more embodiments, the inspection data is to correspond to the dimensions (e.g., diameter, thickness, and/or height) of one or more structural features, such as, for example, a retention feature or bulb feature of fastener 204.

Although gimbal 226 is depicted as connecting telescopic 252 arm 250 and support 222, in some other non-depicted illustrative examples, gimbal 226 can connect inspection sensor 228 to telescopic 252 arm 250. A gimbal can be present when access hole 212 is sufficiently large enough to accommodate a gimbal to extend through access hole 212.

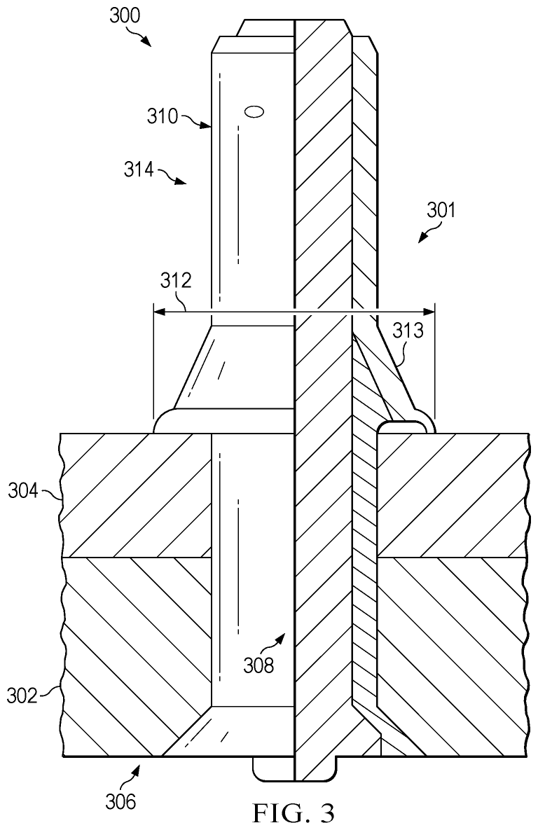

Turning now to FIG. 3, an illustration of a cross-sectional view of a fastener system after installation is depicted in accordance with an illustrative embodiment. In view 300, fastener 301 is depicted in installed state 314. Fastener is a physical implementation of fastener 204 of FIG. 2. Fastener 301 can be used to join components in aircraft 100. For example, fastener 301 can be used in one of body 106, wing 102, or wing 104. Fastener 301 can be inspected by fastener bulb inspection device 202 of FIG. 2 after installation.

As depicted, fastener 301 joins component 302 and component 304. Core 308 of fastener 301 is placed through surface 306 to engage body 310 of fastener 301. Core 308 has been rotated to engage and deform body 310 outwardly forming bulb 313. As depicted, bulb 313 has diameter 312. However, diameter 312 is a single measurement from a single view, it is desirable to inspect the whole of bulb 313 so that any out of tolerance conditions can be detected.

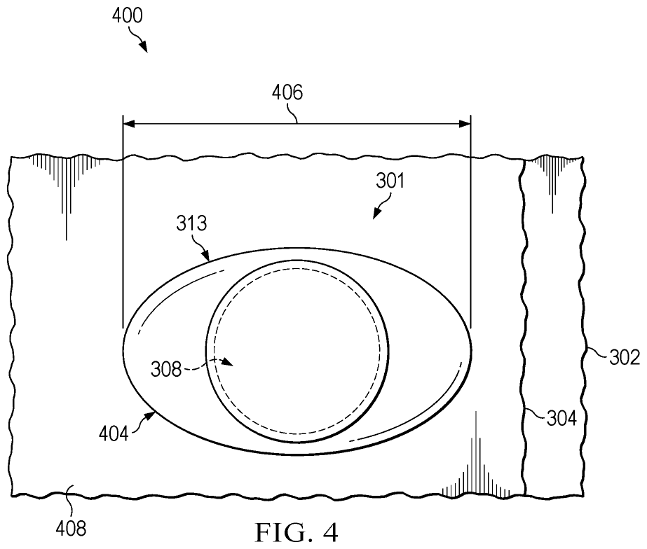

Turning now to FIG. 4, an illustration of a top view of a fastener system after installation is depicted in accordance with an illustrative embodiment. View 400 is a top view of fastener 301 of FIG. 3. In view 400, bulb 313 has non-symmetrical shape 404. In this illustrative example, diameter 406 of bulb 313 is out of tolerance.

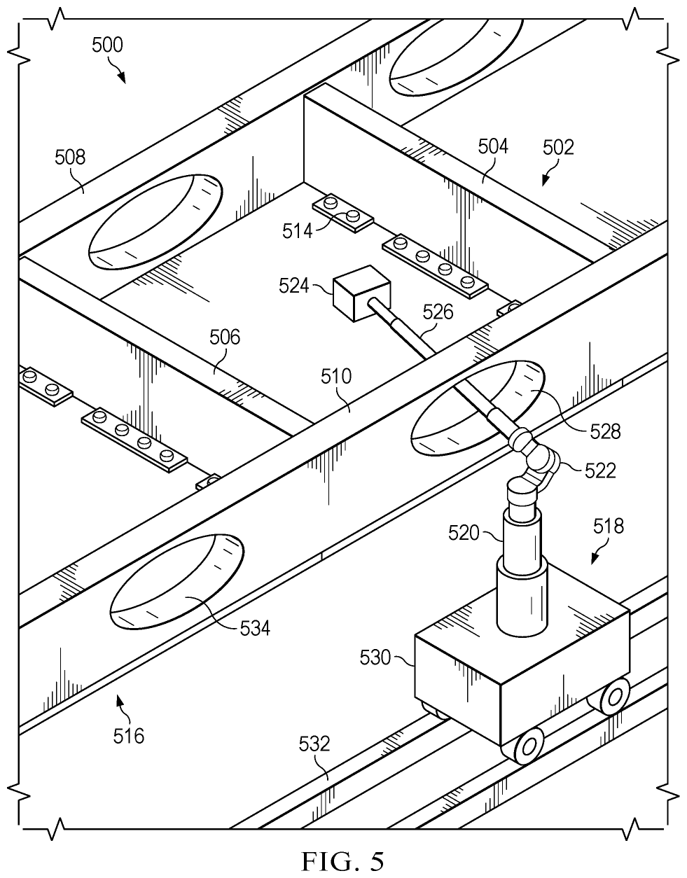

Turning now to FIG. 5, an illustration of a fastener bulb inspection device and a structure with a fastener to be inspected is depicted in accordance with an illustrative embodiment. View 500 is a view of structure 502 in a manufacturing environment. In view 500, a skin of structure 502 has been removed for ease of illustration. In view 500, structure 502 comprises fasteners 514 to be inspected by fastener bulb inspection device 518. Fastener bulb inspection device 518 is a physical implementation of fastener bulb inspection device 202 of FIG. 2. Structure 502 comprises rib 504, rib 506, spar 508, and spar 510 forming confined space 512. Number of fasteners 514 are present in confined space 512 of structure 502. Number of fasteners 514 are not visible outside of structure 502 due to the skin (not depicted) forming confined space 512.

Fastener bulb inspection device 518 is configured to inspect number of fasteners 514 within confined space 512. More specifically, fastener bulb inspection device 518 is configured to inspect at least one of the size or shape of the bulbs of number of fasteners 514. In some illustrative examples, fastener bulb inspection device 518 measures a set number of diameters of the bulbs of number of fasteners 514. In some illustrative examples, fastener bulb inspection device 518 determines if the bulbs of number of fasteners 514 are sufficiently symmetrical. In some illustrative examples, fastener bulb inspection device 518 determines if any of the bulbs of number of fasteners 514 are out of tolerance for size.

Fastener bulb inspection device 518 comprises support 520 providing a desired vertical position relative to access hole 528 of structure 502. Gimbal 522 is connected to support 520. Gimbal 522 enables rotational movement of telescopic arm 526 relative to support 520. Inspection sensor 524 is connected to gimbal 522 by telescopic arm 526.

Inspection sensor 524 is configured to inspect at least one of the size or shape of the bulb of fastener 514. Inspection sensor 524 takes any desirable form. In some illustrative examples, inspection sensor 524 comprises a camera. In some illustrative examples, inspection sensor 524 comprises a laser.

In this illustrative example, support 520 is telescopic. By extending support 520, a vertical position of telescopic arm 526 is changed. The vertical position of telescopic arm 526 can also be adjusted using gimbal 522.

In this illustrative example, fastener bulb inspection device 518 comprises a rail system, where inspection sensor 524 is connected to the rail system to translate relative to structure 502 comprising fastener 514. In this illustrative example, the rail system is connected to the manufacturing floor.

In this illustrative example, support 520 is connected to cart 530. Cart 530 is connected to rail 532. Rail 532 is configured to enable movement of support 520 relative to structure 502. In this illustrative example, rail 532 is configured to be connected to a manufacturing floor.

After inspecting fasteners through access hole 528, cart 530 can move along rail 532 for fastener bulb inspection device 518 to be positioned relative to another access hole, such as access hole 534. After positioning fastener bulb inspection device 518 relative to access hole 534, inspection sensor 524 can be sent through access hole 534 to inspect bulbs of fasteners within an additional confined space in structure 502.

As depicted, gimbal 522 is connected to a first side of telescopic arm 526, and inspection sensor 524 is connected to a second side of telescopic arm 526. Inspection sensor 524 is configured to inspect a bulb of fastener 514.

In some illustrative examples, inspection sensor 524 is part of a number of sensors connected to telescopic arm 526. The number of sensors can comprise any desirable quantity and type of sensors to allow for alignment of inspection sensor 524 and inspection of fastener 514. In some illustrative examples, the number of sensors comprise at least one of a borescope, a camera, a laser, LIDAR, a cup gauge, or a RFID detector.

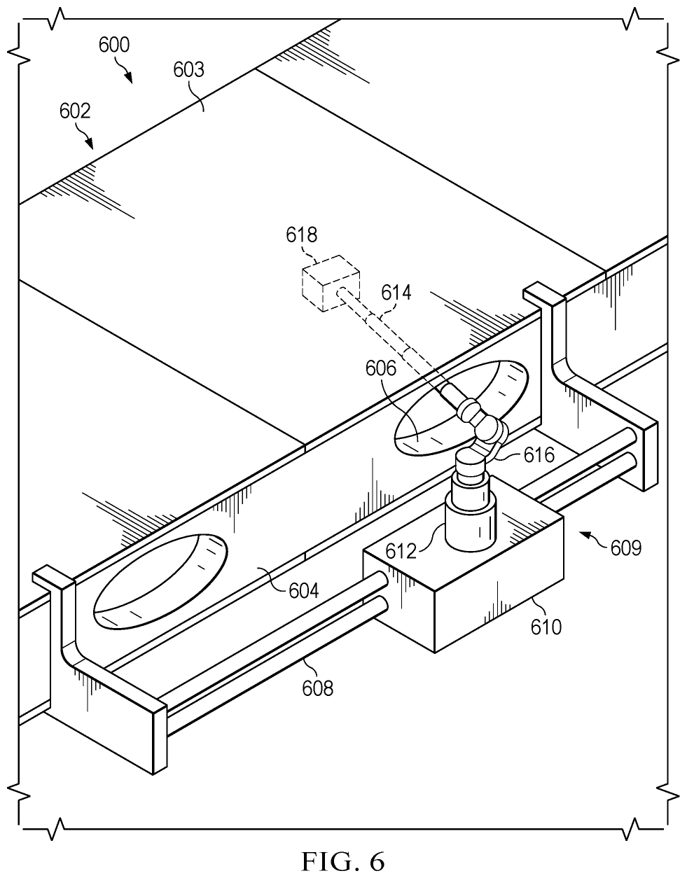

Turning now to FIG. 6, an illustration of a fastener bulb inspection device and a structure with a fastener to be inspected is depicted in accordance with an illustrative embodiment. View 600 is a perspective view of structure 602 with fasteners (not depicted) to be inspected. In view 600, unlike view 500, skin 603 of structure 602 is illustrated. As can be seen in view 600, access to a confined space within structure 602 is possible through access hole 606 of spar 604. As can be seen in view 600, fasteners in structure 602 are not visible from outside of structure 602. Further, if a fastener is visible from outside of structure 602, measurement of the fastener is not possible from outside of structure 602.

In this illustrative example, fastener bulb inspection device 609 is movable relative to access hole 606 on rail 608. Fastener bulb inspection device 609 is a physical implementation of fastener bulb inspection device 202 of FIG. 2. In this illustrative example, rail 608 is connected to fixture 611 supporting structure 602. With rail 608 connected to fixture 611, support 612 can extend a shorter distance to reach access hole 606 than if cart 610 traveled on a rail connected to the manufacturing floor, as in FIG. 5.

In view 600, a telescopic arm 614 connected to gimbal 616 has been extended through access hole 606 to move number of sensors 618 within the confined space of structure 602 to inspect the fasteners (not depicted).

In this illustrative example, fastener bulb inspection device 609 comprises a rail system, where an inspection sensor of number of sensors 618 is connected to the rail system to translate relative to structure 602 comprising the fastener. In this illustrative example, the rail system is connected to a fixture supporting the structure.

In this illustrative example, support 612 is connected to cart 610. Cart 610 is connected to rail 608. Rail 608 is configured to enable movement of support 612 relative to structure 602. In this illustrative example, rail 608 is configured to be connected to a fixture supporting the structure.

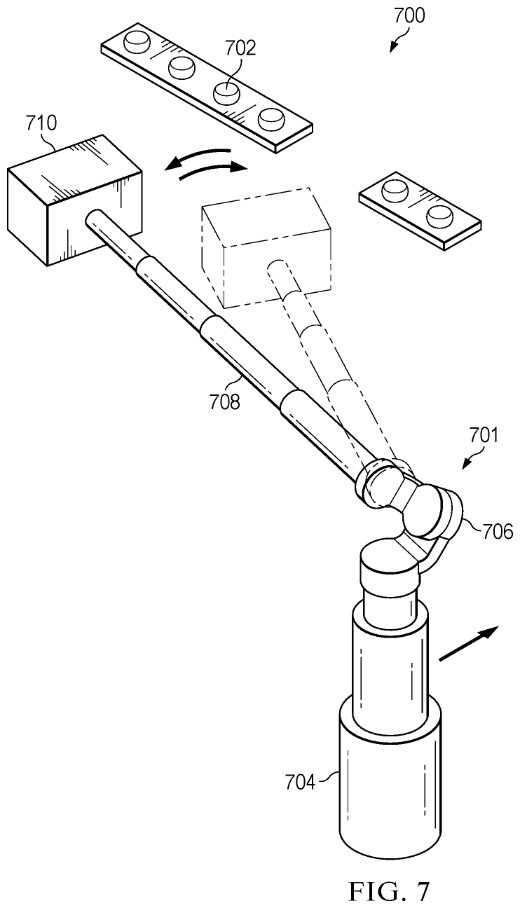

Turning now to FIG. 7, an illustration of a fastener bulb inspection device and a number of fasteners to be inspected is depicted in accordance with an illustrative embodiment. Fastener bulb inspection device 701 is a physical implementation of fastener bulb inspection device 202 of FIG. 2. View 700 is a view of fastener bulb inspection device 701 moving relative to number of fasteners 702 to inspect number of fasteners 702. As depicted in view 700, to move number of sensors 710 relative to number of fasteners 702, telescopic arm 708 can be extended or retracted. Likewise, to move number of sensors 710 relative to number of fasteners 702, telescopic arm 708 can be moved about gimbal 706. Finally, to adjust vertical positioning of number of sensors 710, support 704 can be extended or retracted.

By moving at least one of telescopic arm 708, gimbal 706, or support 704, number of sensors 710 can be positioned over a desired fastener of number of fasteners 702. By moving at least one of telescopic arm 708, gimbal 706, or support 704, number of sensors 710 can be moved in X, Y, and Z directions. Additionally, number of sensors 710 can be rotated by gimbal 706.

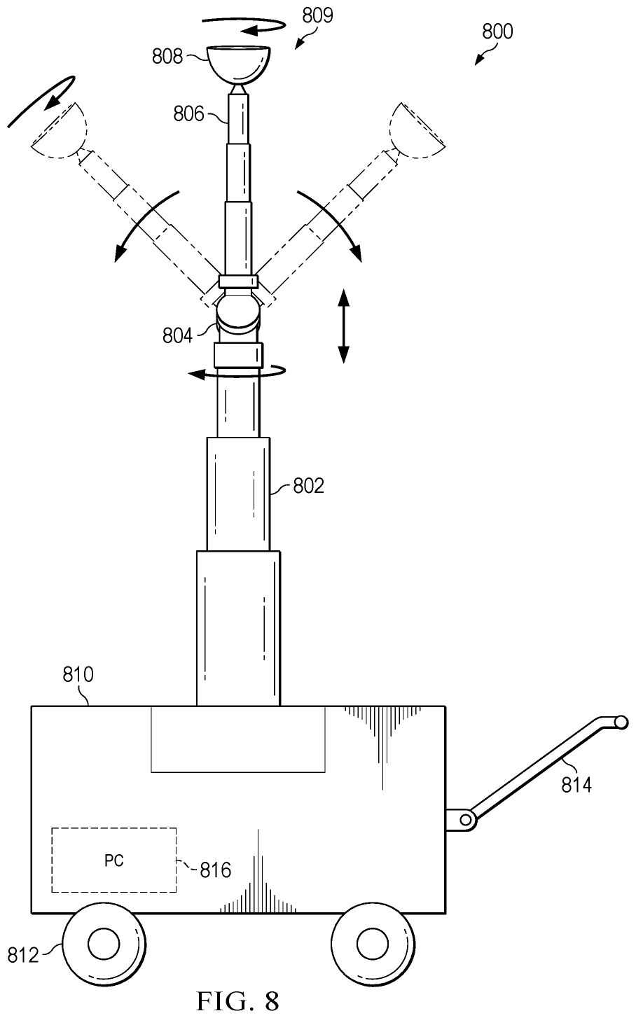

Turning now to FIG. 8, an illustration of a fastener bulb inspection device is depicted in accordance with an illustrative embodiment. Fastener bulb inspection device 701 is a physical implementation of fastener bulb inspection device 202 of FIG. 2. In this illustrative example, support 802 is a telescopic support. Gimbel 804 is connected to support 802 and telescopic arm 806. In this illustrative example, inspection sensor 808 comprises cup gauge 809 for mechanical inspection. Cup gauge 809 allows for detecting if any diameter of a bulb of a fastener is outside of tolerance. If cup gauge 809 does not fit over the bulb of the fastener, at least one portion of the bulb is out of tolerance. Cup gauge 809 is capable of detecting asymmetric bulbs, such as non-circular bulbs that have a portion that is out of tolerance.

In this illustrative example, fastener bulb inspection device 202 is connected to cart 810 that is moved independently of a rail system. In this illustrative example, cart 810 has wheels 812 and handle 814 that allow cart 810 to be maneuvered independently of rails within a manufacturing environment. In this illustrative example, fastener bulb inspection device 202 can be manually maneuvered by an operator within the manufacturing environment.

As depicted, computer system 816 is present on cart 810. Computer system 816 is configured to record inspection data generated by inspection sensor 808 during inspection of bulbs. In some illustrative examples, movement of fastener bulb inspection device 800 is controlled by computer system 816.

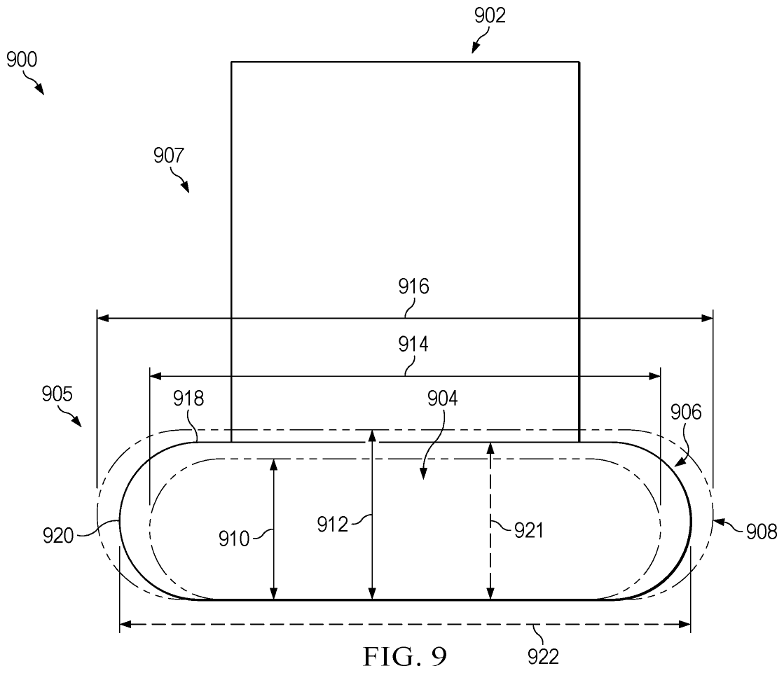

Turning now to FIG. 9, an illustration of an overlay of an image with a bulb and a reference image is depicted in accordance with an illustrative embodiment. In view 900, image 902 of bulb 904 is compared to reference image 905. Image 902 can be an implementation of image 241 of FIG. 2. Image 902 can be an image of bulb 214 of FIG. 2. Bulb 904 can be an implementation of bulb 313 of FIGS. 3 and 4. Image 902 can be an image of any of fasteners 514 of FIG. 5. Image 902 can be generated by number of sensors 618 of FIG. 6. Image 902 can be generated by number of sensors 710 of FIG. 7.

To determine if bulb 904 of fastener 907 is within tolerance by comparing image 902 to reference image 905. In some illustrative examples, comparing image 902 to reference image 905 comprises identifying bulb edge 906 in image 902. In some illustrative examples, comparing image 902 to reference image 905 comprises identifying if the bulb edge 906 extends past bulb boundary 908 in reference image 905.

Bulb boundary 908 comprises minimum height 910 and maximum height 912 for a bulb to be in tolerance. Bulb boundary 908 comprises minimum diameter 914 and maximum diameter 916 for a bulb to be in tolerance.

As depicted, bulb edge 906 is positioned within bulb boundary 908. Accordingly, bulb 904 can be determined to be in tolerance.

In some illustrative examples, identifying bulb edge 906 comprises identifying at least one of side 920 of bulb 904 or top 918 of bulb 904. In some illustrative examples, determining if bulb 904 of fastener 907 is within tolerance comprises determining bulb 904 is out of tolerance if top 918 is above or below bulb boundary 908. In some illustrative examples, determining if bulb 904 of fastener 907 is within tolerance comprises determining bulb 904 is out of tolerance if side 920 is outside of bulb boundary 908. In some illustrative examples, determining if bulb 904 of fastener 907 is within tolerance comprises determining bulb 904 is out of tolerance if any portion of bulb edge 906 extends outside of bulb boundary 908.

In this illustrative example, comparing image 902 to reference image 905 comprises overlaying reference image 905 and image 902. In some illustrative examples, determining if the bulb of the fastener is within tolerance comprises determining at least one of if diameter 922 of bulb 904 is in tolerance or if a height 921 of bulb 904 is in tolerance.

In this illustrative example, bulb edge 906 is within bulb boundary 908. In this illustrative example, bulb 904 is in tolerance.

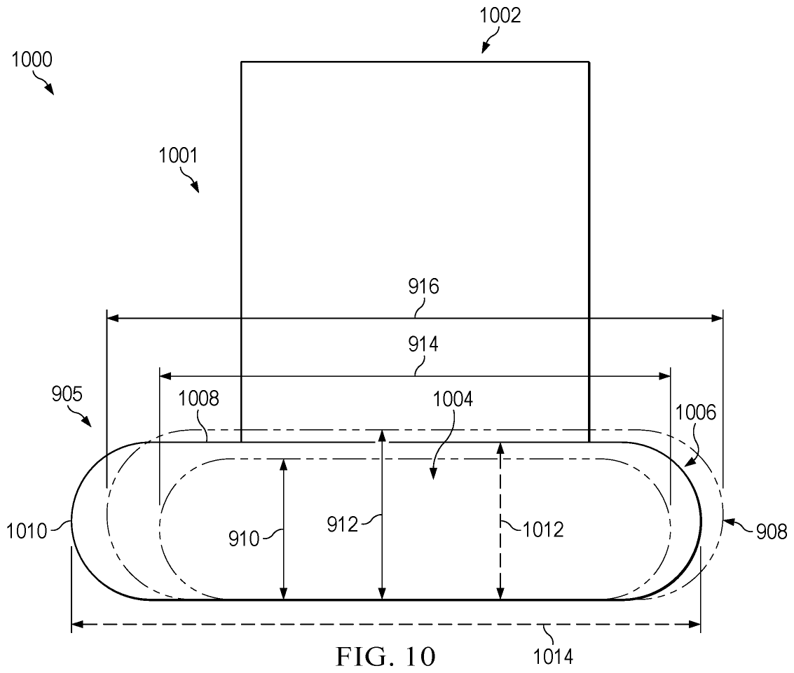

Turning now to FIG. 10, an illustration of an overlay of an image with a bulb and a reference image is depicted in accordance with an illustrative embodiment. View 1000 is a view of image 1002 overlaid with reference image 905. In view 1000, bulb 1004 of fastener 1001 has bulb edge 1006. Bulb edge 1006 has top 1008 and side 1010. In this illustrative example, height 1012 of bulb 1004 is in tolerance. In this illustrative example, diameter 1014 of bulb 1004 is out of tolerance.

In this illustrative example, bulb edge 1006 extends outside of bulb boundary 908. In this illustrative example, side 1010 of bulb edge 1006 is outside of bulb boundary 908. In this illustrative example, comparing bulb edge 1006 of image 1002 to bulb boundary 908 of reference image 905 identifies an out of tolerance condition.

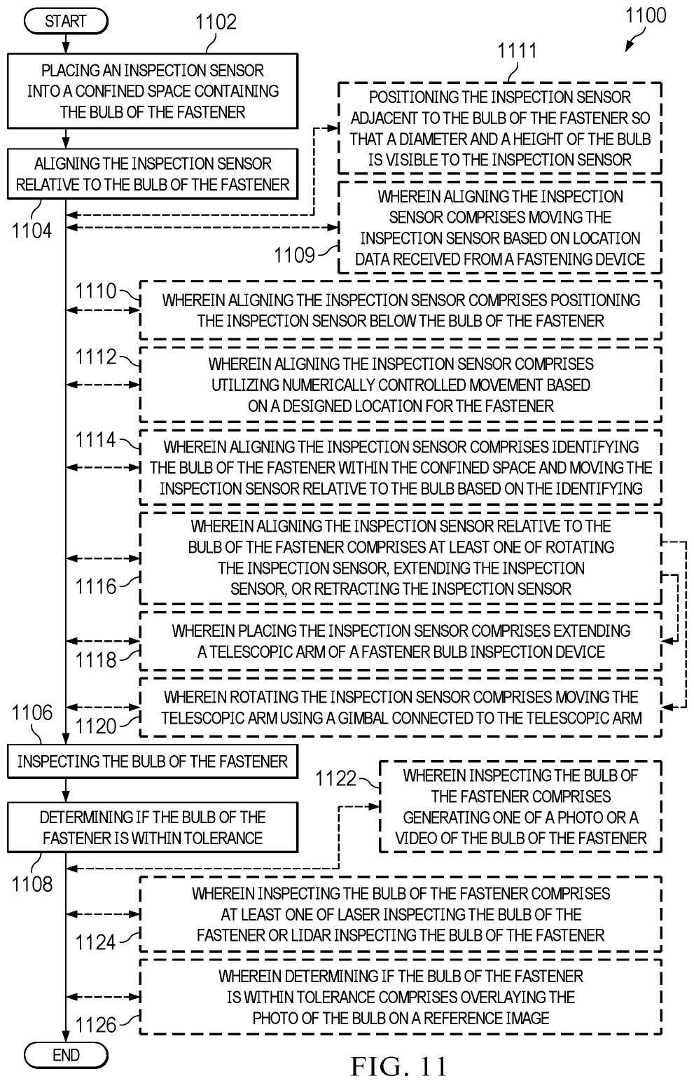

Turning now to FIG. 11, a flowchart of a method of inspecting a bulb of a fastener is depicted in accordance with an illustrative embodiment. Method 1100 can be performed using fastener bulb inspection device 202 of FIG. 2. Method 1100 can be performed to inspect fastener 301 of FIGS. 3 and 4 after installation. Method 1100 can be performed using fastener bulb inspection device 518 of FIG. 5. Method 1100 can be performed using fastener bulb inspection device 609 of FIG. 6. Method 1100 can be performed using fastener bulb inspection device 703 of FIG. 7. Method 1100 can be performed using fastener bulb inspection device 800 of FIG. 8.

Method 1100 places an inspection sensor into a confined space containing the bulb of the fastener (operation 1102). Method 1100 aligns the inspection sensor relative to the bulb of the fastener (operation 1104). Method 1100 inspects the bulb of the fastener (operation 1106). Method 1100 determines if the bulb of the fastener is out of tolerance (operation 1108). Afterwards, method 1100 terminates.

In some illustrative examples, the bulb of the fastener can be inspected after fastening operations are completed and the bulb is formed. In some illustrative examples, the bulb of the fastener can be inspected during forming of the bulb. For example, images or videos of the bulb can be taken as the bulb is formed.

In some illustrative examples, aligning the inspection sensor comprises moving the inspection sensor based on location data received from a fastening device (operation 1109). In some illustrative examples, aligning the inspection sensor comprises positioning the inspection sensor above the bulb of the fastener (operation 1110). In some illustrative examples, aligning the inspection sensor comprises positioning the inspection sensor so that the whole of the bulb is visible to the inspection sensor. In some illustrative examples, aligning the inspection sensor comprises positioning the inspection sensor adjacent the bulb of the fastener so that a diameter and a height of the bulb is visible to the inspection sensor (operation 1111).

In some illustrative examples, aligning the inspection sensor comprises utilizing numerically controlled movement based on a designed location for the fastener (operation 1112). In some illustrative examples, inspection of the fastener can be performed after aligning the inspection sensor based on the designed location. In some other illustrative examples, the designed location provides an initial location for aligning the inspection sensor. In some illustrative examples, after moving to the initial location, the number of sensors perform a further alignment based on a detected location of the fastener to position the number of sensors relative to the fastener prior to inspecting the fastener.

In some illustrative examples, aligning the inspection sensor comprises identifying the bulb of the fastener within the confined space and moving the inspection sensor relative to the bulb based on the identifying (operation 1114). Identifying the bulb can take any desirable form. In some illustrative examples, the bulb is identified using at least one of a camera, a borescope, a UV sensor, a cup gauge, or other desirable sensor.

In some illustrative examples, aligning the inspection sensor relative to the bulb of the fastener comprises at least one of rotating the inspection sensor, extending the inspection sensor, or retracting the inspection sensor (operation 1116). In some illustrative examples, placing the inspection sensor comprises extending a telescopic arm of a fastener bulb inspection device (operation 1118). In some illustrative examples, rotating the inspection sensor comprises moving the telescopic arm using a gimbal connected to the telescopic arm (operation 1120).

In some illustrative examples, inspecting the bulb of the fastener comprises generating one of a photo or a video of the bulb of the fastener (operation 1122). In some illustrative examples, inspecting the bulb of the fastener comprises at least one of laser inspecting the bulb of the fastener or LIDAR inspecting the bulb of the fastener (operation 1124). In some illustrative examples, determining if the bulb of the fastener is within tolerance comprises overlaying the photo of the bulb on a reference image (operation 1126).

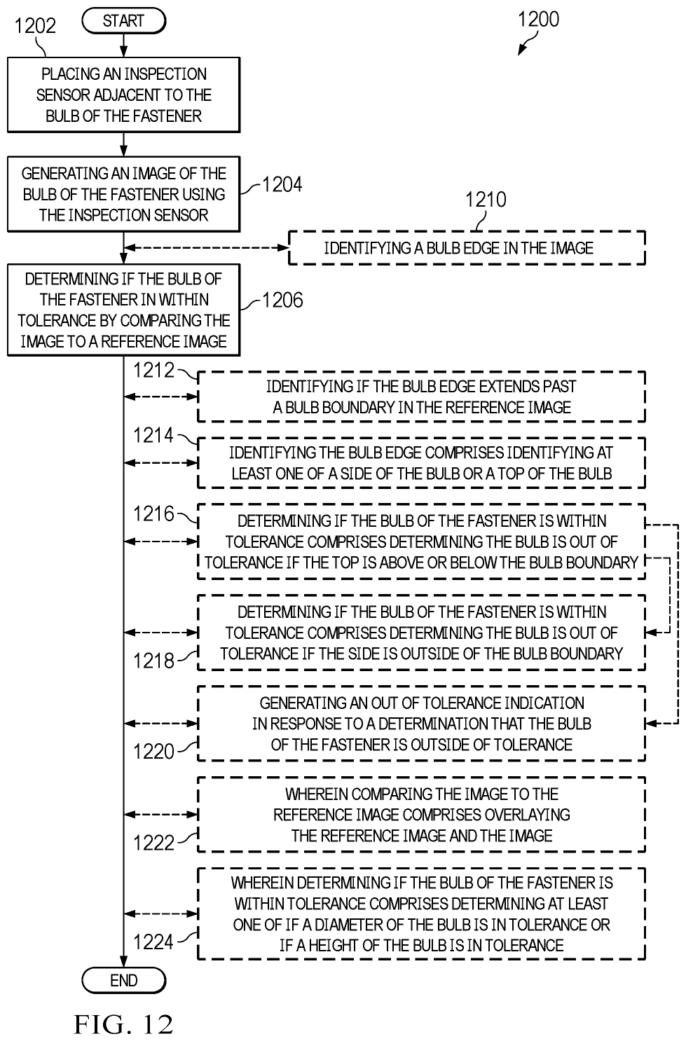

Turning now to FIG. 12, a flowchart of a method of inspecting a bulb of a fastener is depicted in accordance with an illustrative embodiment. Method 1200 can be performed using fastener bulb inspection device 202 of FIG. 2. Method 1200 can be performed to inspect fastener 301 of FIGS. 3 and 4 after installation. Method 1200 can be performed using fastener bulb inspection device 518 of FIG. 5. Method 1200 can be performed using fastener bulb inspection device 609 of FIG. 6. Method 1200 can be performed using fastener bulb inspection device 703 of FIG. 7. Method 1200 can be performed using fastener bulb inspection device 800 of FIG. 8. Method 1200 can be performed using an overlay such as view 900 of FIG. 9. Method 1200 can be performed using an overlay such as view 1000 of FIG. 10.

Method 1200 places an inspection sensor adjacent a bulb of a fastener (operation 1202). Method 1200 generates an image of the bulb of the fastener using the inspection sensor (operation 1204). Method 1200 determines if the bulb of the fastener is within tolerance by comparing the image to a reference image (operation 1206). Afterwards, method 1200 terminates.

In some illustrative examples, comparing the image to the reference image comprises identifying a bulb edge in the image (operation 1210), and identifying if the bulb edge extends past a bulb boundary in the reference image (operation 1212). In some illustrative examples, identifying the bulb edge comprises identifying at least one of a side of the bulb or a top of the bulb (operation 1214).

In some illustrative examples, determining if the bulb of the fastener is within tolerance comprises determining the bulb is out of tolerance if the top is above or below the bulb boundary (operation 1216). In some illustrative examples, determining if the bulb of the fastener is within tolerance comprises determining the bulb is out of tolerance if the side is outside of the bulb boundary (operation 1218).

In some illustrative examples, method 1200 generates an out of tolerance indication in response to a determination that the bulb of the fastener is outside of tolerance (operation 1220). In some illustrative examples, comparing the image to the reference image comprises overlaying the reference image and the image (operation 1222). In some illustrative examples, determining if the bulb of the fastener is within tolerance comprises determining at least one of if a diameter of the bulb is in tolerance or if a height of the bulb is in tolerance (operation 1224).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1110 through operation 1124 may be optional.

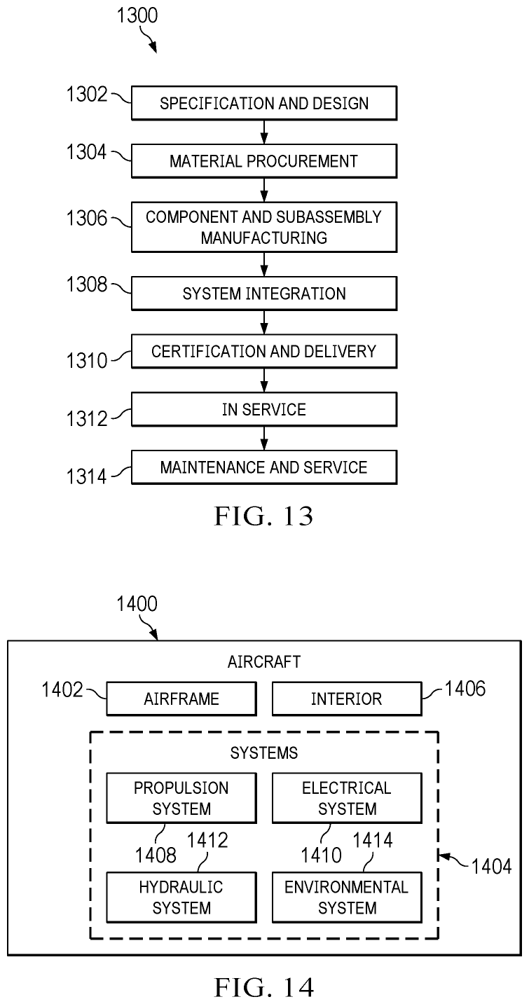

Illustrative embodiments of the present disclosure may be described in the context of aircraft manufacturing and service method 1300 as shown in FIG. 13 and aircraft 1400 as shown in FIG. 14. Turning first to FIG. 13, an illustration of an aircraft manufacturing and service method in a form of a block diagram is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 takes place. Thereafter, aircraft 1400 may go through certification and delivery 1310 in order to be placed in service 1312. While in service 1312 by a customer, aircraft 1400 is scheduled for routine maintenance and service 1314, which may include modification, reconfiguration, refurbishment, or other maintenance and service.

Each of the processes of aircraft manufacturing and service method 1300 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft in a form of a block diagram is depicted in which an illustrative embodiment may be implemented. In this example, aircraft 1400 is produced by aircraft manufacturing and service method 1300 of FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included.

Apparatuses and methods embodied herein may be employed during at least one of the stages of aircraft manufacturing and service method 1300. One or more illustrative embodiments may be manufactured or used during at least one of component and subassembly manufacturing 1306, system integration 1308, in service 1312, or maintenance and service 1314 of FIG. 13.

Fastener bulb inspection device 202 of FIG. 2 can be used during component and subassembly manufacturing 1306, system integration 1308, or maintenance and service 1314 of FIG. 13 to inspect bulbs of fasteners. Fastener bulb inspection device 202 of FIG. 2 can be used to inspect fastener bulbs in at least one of airframe 1402 or interior 1406. Method 1100 can be performed to inspect portions of airframe 1402 or interior 1406. Method 1100 can be performed during at least one of component and subassembly manufacturing 1306, system integration 1308, or maintenance and service 1314 of FIG. 13.

The illustrative examples provide for bulb inspection of fasteners within confined spaces without the use of robotic systems. A fastener bulb inspection device utilizing hard tooling is provided. The fastener bulb inspection device provides for inspection of the whole bulb of the fastener.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A fastener bulb inspection device comprising:
a support providing a desired vertical position relative to an access hole of a structure with a fastener to be inspected;
a gimbal connected to the support; and
an inspection sensor connected to the gimbal by a telescopic arm.

2. The fastener bulb inspection device of claim 1, wherein the support is telescopic.

3. The fastener bulb inspection device of claim 1 further comprising:
a cart connected to the support; and
a rail configured to enable movement of the support relative to the structure.

4. The fastener bulb inspection device of claim 3, wherein the rail is configured to be connected to a fixture supporting the structure or connected to the structure.

5. The fastener bulb inspection device of claim 3, wherein the rail is configured to be connected to a manufacturing floor.

6. The fastener bulb inspection device of claim 1, wherein the inspection sensor comprises a cup gauge for mechanical inspection.

7. The fastener bulb inspection device of claim 1, wherein the inspection sensor comprises a camera.

8. The fastener bulb inspection device of claim 7 further comprising a computer system with an image comparator configured to identify an out of tolerance bulb in an image generated by the camera.

9.-11. (canceled)

12. A fastener bulb inspection device comprising:
a telescopic arm;
a gimbal connected to a first side of the telescopic arm; and
an inspection sensor connected to a second side of the telescopic arm, the inspection sensor configured to inspect a bulb of a fastener.

13-15. (canceled)

16. The fastener bulb inspection device of claim 12, wherein the inspection sensor is part of a number of sensors connected to the telescopic arm, wherein the number of sensors comprise at least one of a borescope, a camera, a laser, LIDAR, a cup gauge, or a RFID detector.

17. The fastener bulb inspection device of claim 16, wherein the number of sensors comprises at least one sensor configured to perform alignment of the inspection sensor.

18. A method of inspecting a bulb of a fastener comprising:
placing an inspection sensor into a confined space containing the bulb of the fastener;
aligning the inspection sensor relative to the bulb of the fastener;
inspecting the bulb of the fastener; and
determining if the bulb of the fastener is within tolerance.

19-20. (canceled)

21. The method of claim 18, wherein aligning the inspection sensor comprises utilizing numerically controlled movement based on a designed location for the fastener.

22. (canceled)

23. The method of claim 18, wherein inspecting the bulb of the fastener comprises generating one of a photo or a video of the bulb of the fastener.

24. The method of claim 23, wherein determining if the bulb of the fastener is within tolerance comprises overlaying the photo of the bulb on a reference image.

25. The method of claim 18, wherein inspecting the bulb of the fastener comprises at least one of laser inspecting the bulb of the fastener or LIDAR inspecting the bulb of the fastener.

26. The method of claim 18, wherein aligning the inspection sensor relative to the bulb of the fastener comprises at least one of rotating the inspection sensor, extending the inspection sensor, or retracting the inspection sensor.

27. (canceled)

28. The method of claim 27, wherein rotating the inspection sensor comprises moving the telescopic arm using a gimbal connected to the telescopic arm.

29. (canceled)

30. A method of inspecting a bulb of a fastener comprising:
placing an inspection sensor adjacent a bulb of a fastener;
generating an image of the bulb of the fastener using the inspection sensor; and
determining if the bulb of the fastener is within tolerance by comparing the image to a reference image.

31. The method of claim 30, wherein comparing the image to the reference image comprises:
identifying a bulb edge in the image; and
identifying if the bulb edge extends past a bulb boundary in the reference image.

32. The method of claim 31, wherein identifying the bulb edge comprises identifying at least one of a side of the bulb or a top of the bulb.

33. The method of claim 32, determining if the bulb of the fastener is within tolerance comprises determining the bulb is out of tolerance if the top is above or below the bulb boundary.

34. The method of claim 32, determining if the bulb of the fastener is within tolerance comprises determining the bulb is out of tolerance if the side is outside of the bulb boundary.

35-37. (canceled)
